(19) United States
(12) Patent Application Publication
(10) Pub. No.: US 2004/0150594 A1
(43) Pub. Date: Aug. 5, 2004

(54) Display device and drive method therefor

(75) Inventors: Jun Koyama, Sagamihara (JP); Mitsuaki Osame, Atsugi (JP)

Correspondence Address: NIXON PEABODY, LLP, 401 9TH STREET, NW, SUITE 900, WASINGTON, DC, 20004-2128, US

(73) Assignee: Semiconductor Energy Laboratory Co., Ltd., Atsugi-shi (JP)

(21) Appl. No.: 10/623,857

(22) Filed: Jul. 22, 2003

(30) Foreign Application Priority Data
Jul. 25, 2002 (JP) 2002-216973

(51) Int. Cl. G09G 3/32

(52) U.S. Cl. 345/82

(57) ABSTRACT

A light-emitting element has a characteristic that deterioration caused not only by aging but also by temperature change occurs. The present invention is characterized by having two compensation functions of an aging compensation function and a temperature compensation function (hereinafter collectively referred to as compensation function) in order to correct temperature change and deterioration caused by temperature change. The compensation function, which is a key of the present invention, is characterized by including: a temperature detection unit which detects an ambient temperature; a storage unit having stored therein a temperature characteristic and an aging characteristic of the light-emitting element; an arithmetic operation unit which calculates a lighting period of each pixel using an output of the temperature detection unit, the temperature characteristic, and a video signal; a count unit which detects a cumulated lighting period of each pixel using an output of the arithmetic operation unit; and a correction unit which corrects a video signal to be inputted to each pixel or a power supply potential using the aging characteristic and the cumulated lighting period.

### BACKGROUND OF THE INVENTION

1. Field of the Invention

The present invention relates to a technique for a display device and, more specifically, to a display device including a unit for correcting deteriorations resulting mainly from an aging change and a temperature change.

2. Description of the Related Arts

In recent years, the development of a display device for displaying an image has been progressed. As the display device, a liquid crystal display device for displaying an image using a liquid crystal element has been widely used by taking advantages of a high image quality, a thin form, a light weight, and the like. On the other hand, the development of a display device using a light-emitting element has been also progressed in recent years. The display device using the light-emitting element has features such as a high response speed, superior moving picture display, and a wide viewing characteristic in addition to an advantage of an existing liquid crystal display device. Therefore, the display device using the light-emitting element has been drawn keen attention.

In the display device using the light-emitting element, a plurality of pixels each having a light-emitting element and at least two transistors are provided. In each pixel, a transistor connected in series with the light-emitting element (hereinafter indicated as a driving transistor) has a function of controlling light emission of the light-emitting element. When a gate-source voltage (hereinafter indicated as VGS) of the driving transistor and a source-drain voltage (hereinafter indicated as VDS) thereof are changed as appropriate, the driving transistor can be operated in a saturation region or in a linear region.

When the driving transistor is operated in the saturation region (|V_{GS}-Vₜₕ|<|V_{DS}|), the current value of the light-emitting element is dependent on a change in |V_{GS}| of the driving transistor, but hardly dependent on a change in |V_{DS}|. A driving method of operating the driving transistor in the saturation region is called constant current drive. FIG. 8A is a schematic view of a pixel to which the constant current drive is applied. In the constant current drive, the gate voltage of the driving transistor is controlled to allow the necessary amount of current to flow into the light-emitting element. In other words, the driving transistor is used as a voltage control current source and set such that a constant current flows between a power source line and the light-emitting element.

On the other hand, when the driving transistor is operated in the linear region (|V_{GS}-Vₜₕ|>|V_{DS}|), the current value of the light-emitting element is changed depending on both values of |V_{GS}| and |V_{DS}|. A driving method of operating the driving transistor in the linear region is called constant voltage drive. FIG. 8B is a schematic view of a pixel to which the constant voltage drive is applied. In the constant voltage drive, the driving transistor is used as a switch, and the power source line and the light-emitting element are shorted if necessary, thereby allowing a current to flow into the light-emitting element.

The light-emitting element has a property in which a resistance value is increased according to an aging. In other words, the current value of the light-emitting element is decreased according to an aging and the light-emitting element has the property of changing of its luminance. Such a aging deterioration is corrected for example by a lighting period of each pixel (for example, refer to the Japanese Patent Laid-Open No. 2002-175041).

The light-emitting element has a characteristic that deterioration caused not only by aging but also by temperature change occurs. FIG. 9 shows a graph representing a relation between a time on a horizontal axis and a life of the light-emitting element on a vertical axis. From this graph, it is seen that the light-emitting element deteriorates due to aging, and the life thereof depends upon the time. In addition, when temperatures T1 to T3 satisfy a condition T1>T2>T3, a half-life is AT in the case that a temperature at the time when the display device is used (hereinafter referred to as environmental temperature) is T2, and a half-life is 2AT in the case that the environmental temperature is T3. That is, the life of the light-emitting element largely depends upon a temperature.

When deterioration occurs in the light-emitting element due to aging and temperature change, fluctuation occurs in luminance or a display pattern is burnt even if the same amount of current is flown to each pixel. That is, it becomes difficult to display an image represented in an accurate gradation, which results in spoiling reliability of the display device.

### SUMMARY OF THE INVENTION

The present invention has been devised in view of the above-mentioned circumstances. It is an object of the present invention to provide a display device, which corrects deterioration caused by aging and temperature change is capable of displaying a high quality image, and further has improved reliability, and a drive method therefor.

In view of the above-mentioned circumstances, the present invention is characterized by having two compensation functions of an aging compensation function and a temperature compensation function (hereinafter collectively referred to as compensation function) in order to correct temperature change and deterioration caused by temperature change. The compensation function, which is a key of the present invention, includes a temperature detection unit, a storage unit, an arithmetic operation unit, a correction unit, and a count unit.

The temperature detection unit has a function of detecting an environmental temperature. A publicly known temperature detection element such as a thermocouple, a diode, or a light-emitting element for temperature monitor is used as the temperature detection unit.

The storage unit is constituted using a publicly known storage circuit and stores data of the temperature characteristic of the light-emitting element and data of the aging characteristic at each temperature of the light-emitting element. Note that the data of the temperature characteristic of the light-emitting element is equivalent to data of an acceleration factor corresponding to each temperature. In addition, the data of the aging characteristic at each temperature of the light-emitting element is equivalent to data showing a relation between a time and light emission luminance, a current-voltage characteristic, or the like of the light-emitting element corresponding to each temperature.

The arithmetic operation unit is constituted using a publicly known arithmetic circuit and has a function of performing arithmetic operation. More specifically, the arithmetic operation unit calculates a lighting period of each pixel using an output of the temperature detection unit, the temperature characteristic, and a video signal. For example, the arithmetic operation unit calculates an acceleration factor corresponding to a detected temperature from an output of the temperature detection unit and the data of the acceleration factor corresponding to each temperature stored in the storage unit. Then, the arithmetic operation unit calculates a multiplication of data of the lighting period of each pixel supplied from the video signal and the acceleration factor.

If the environmental temperature is higher than a room temperature, a lighting period longer than an actual lighting period is obtained as an arithmetic operation result by setting a value of an acceleration factor of the environmental temperature to more. On the other hand, if the environmental temperature is equal to or lower than the room temperature, a lighting period equal to or shorter than the actual lighting period is obtained as an arithmetic operation result by setting an acceleration factor of the environmental temperature to one or less. In this way, the actual lighting period of the pixel is corrected to a lighting period corresponding to the environmental temperature.

The count unit is constituted using a publicly known counter circuit and finds a cumulative lighting period in each pixel using an output of the arithmetic operation unit.

The correction unit is roughly divided into a signal correction unit and a voltage correction unit, both of which use the data of the aging characteristic at each temperature stored in the storage unit and an output of the count unit. The signal correction unit corrects a signal to be inputted to each pixel and is applied to both a constant voltage drive and a constant current drive. The voltage correction unit corrects a power supply voltage to be supplied to each pixel or entire pixel portion and is applied to only the constant voltage drive.

In addition, a sampling unit may be arranged for the compensation function of the present invention. The sampling unit is constituted using a publicly known sampling circuit and has a function of detecting a lighting period of each pixel efficiently by sampling a video signal inputted to the each pixel.

The present invention having the above-mentioned structure corrects deterioration caused by both temperature change and aging, and provides a display device which is capable of displaying a high quality image and has improved reliability. Moreover, in the present invention, since an operation by a user is not required basically, a long life of the display device as a product can be expected by continuing correction even after it is delivered to an end user.

### BRIEF DESCRIPTION OF THE DRAWINGS

FIG. 1 is a diagram showing a display device of the present invention;

FIG. 2 is a diagram showing a display device of the present invention;

FIGS. 3A and 3B are graphs showing a relation between a temperature and an acceleration factor;

FIG. 4 is a diagram showing a temperature detection unit;

FIGS. 5A to 5E are diagrams showing a display device of the present invention;

FIGS. 6A to 6C are diagrams showing a display device of the present invention;

FIGS. 7A to 7H illustrate electronic apparatuses to which the present invention is applied;

FIGS. 8A and 8B are conceptual diagrams of a constant current drive and a constant voltage drive;

FIG. 9 is a graph showing a relation between a time and a life;

FIG. 10 is a diagram showing a display device of the present invention; and

FIG. 11 is a diagram of a column signal line drive circuit.

### DESCRIPTION OF THE PREFERRED EMBODIMENT

### Embodiment 1

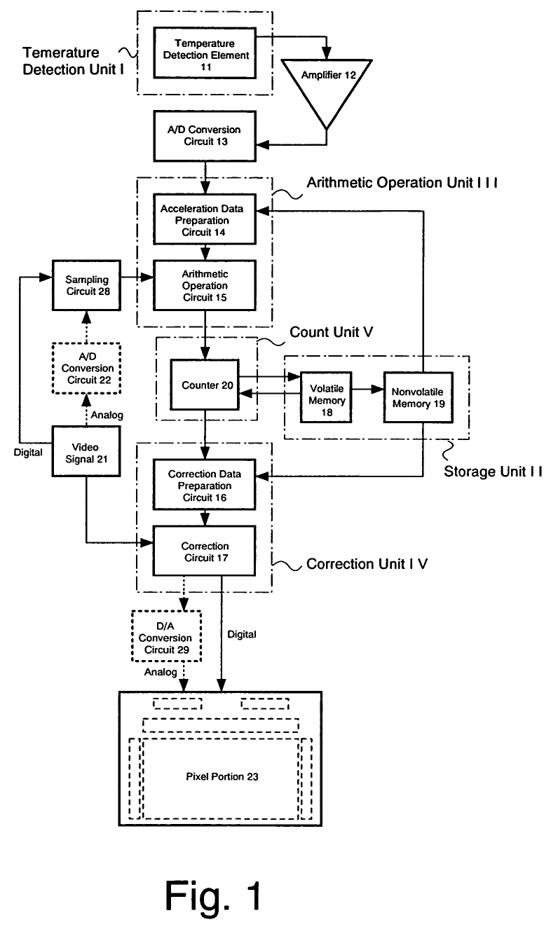

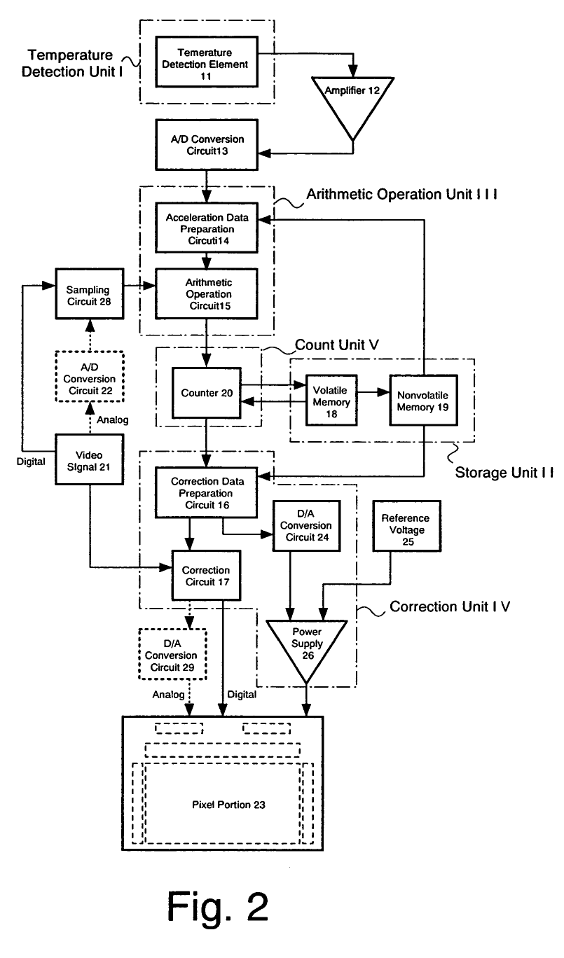

A first structure of a display device having a compensation function of the present invention will be described with reference to FIG. 1. A second structure of the same will be described with reference to FIG. 2.

In FIG. 1, the compensation function, which is a key of the present invention, consists of a temperature detection unit I, a storage unit II, an arithmetic operation unit III, a correction unit IV, and a count unit V. The temperature detection unit I has a temperature detection element 11, the storage unit II has a volatile memory 18 and a nonvolatile memory 19, the arithmetic operation unit III has an acceleration data preparation circuit 14 and an arithmetic operation circuit 15, the correction unit IV has a correction data preparation circuit 16 and a correction circuit 17, and the count unit V has a counter 20. In addition, other than the above, the compensation function has an amplifier 12, A/D conversion circuits 13 and 22, a sampling circuit 28, and a D/A conversion circuit 29.

Here, an operation of each circuit will be described. First, data of an acceleration factor corresponding to each temperature (data of a temperature characteristic) and data of a relation between a time and a current-voltage characteristic corresponding to each temperature (data of an aging characteristic) are stored in the storage unit II in advance. This data is used in the arithmetic operation unit III and the correction unit IV. Note that it is preferable that data to be stored in the storage unit II has already been stored at the time of product shipment and does not require an operation by a user thereafter. However, data to be stored in the storage unit II may be corrected by a user arbitrarily depending on demands. For example, in the case in which the display device of the present invention is mounted on a portable terminal, the user may download data and correct the data.

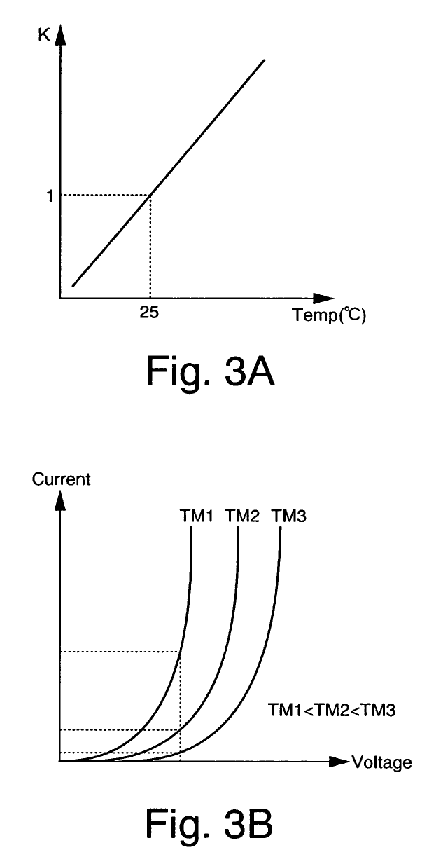

Data of an acceleration factor (K) corresponding to each temperature corresponds to data as shown in FIG. 3A. For example, assuming that the acceleration factor is 1 at a room temperature (25° C.), the temperature and the acceleration factor are in a proportional relation with a constant inclination. However, the present invention is not limited to this. Since a speed of deterioration of a light-emitting element may differ depending upon a temperature, the inclination of the proportional relation of the temperature and the acceleration factor may not always be constant. For example, an inclination at the room temperature or more and an inclination at the room temperature or less may be set to be different. The inclination may be represented by a curved line without being limited to a straight line.

In addition, data of a relation between a time and a current-voltage characteristic corresponding to each temperature corresponds to data as shown in FIG. 3B. In a graph of FIG. 3B, a current value changes due to an aging factor when the same voltage is applied as shown by dotted lines.

When an environmental temperature is detected by the temperature detection element 11, data is supplied to the amplifier (analog amplifier) 12 from the temperature detection element 11. The data supplied from the temperature detection element 11 is amplified by the amplifier 12, and then, supplied to the A/D conversion circuit 13. The A/D conversion circuit 13 converts data supplied from the amplifier 12 into digital data.

The acceleration data preparation circuit 14 prepares acceleration data using the digital date supplied from the A/D conversion circuit 13 and the data of the acceleration factor corresponding to each temperature stored in the storage unit II. This acceleration data is equivalent to information on an acceleration factor corresponding to an environmental temperature.

A video signal 21 is roughly divided into two video signals, namely, an analog video signal and a digital video signal. Which video signal is to be used depends upon which of the analog drive and the digital drive the display device adopts. In the case of the analog drive, the analog video signal is converted into the digital video signal using the A/D conversion circuit 22, and then, supplied to the sampling circuit 28. In the case of the digital drive, the digital video signal is directly supplied to the sampling circuit 28. The sampling circuit 28 periodically samples the video signal 21 inputted to each pixel, thereby detecting a lighting period of each pixel. Note that the sampling circuit 28 is not an essential element of the present invention, and a lighting period may be detected by supplying the video signal 21 to the arithmetic operation circuit 15.

The arithmetic operation circuit 15 calculates a multiplication of the acceleration data to be supplied from the acceleration data preparation circuit 14 and the lighting period of each pixel to be supplied from the sampling circuit 28. More specifically, for example, in the case in which an environmental temperature is higher than a room temperature, data considered to be a lighting period longer than an actual lighting period is prepared by setting a value of an acceleration factor of the environmental temperature to more. On the other hand, if the environmental temperature is equal to or lower than the room temperature, data considered to be a lighting period equal to or shorter than the actual lighting period is prepared by setting a value of an acceleration factor of the environmental temperature to one or less.

The counter 20 counts a corrected lighting period outputted from the arithmetic operation circuit 15 and finds a cumulative lighting period. A lighting period of each pixel counted here is sequentially stored in the volatile memory 18. Since this lighting period is cumulated, it is preferable to constitute the storage unit II using the nonvolatile memory 19. However, since the number of times of writing in the nonvolatile memory 19 is generally limited, it is preferable to use the volatile memory 18 when the display device is operating, and the lighting period is written in the nonvolatile memory 19 at every fixed period.

The correction data preparation circuit 16 prepares correction data using the data to be supplied from the counter 20 and the data of a relation between a time and a current-voltage characteristic corresponding to each temperature stored in the storage unit II.

Subsequently, the correction circuit 17 crosses the correction data to be supplied from the correction data preparation circuit 16 and the video signal 21, and corrects the video signal 21 to a signal suitable for aging and temperature change. Then, in the case of the analog drive, the digital video signal to be supplied from the correction circuit 17 is converted into an analog video signal using the D/A conversion circuit 29 and supplied to a pixel portion 23. In the case of the digital drive, the digital video signal to be supplied from the correction circuit 17 is directly supplied to the pixel portion 23.

As described above, in the present invention, a lighting period is detected using a video signal inputted to a pixel, and an environmental temperature is further detected using a temperature detection unit. Then, the lighting period is corrected according to the environmental temperature, and the signal is corrected using the corrected lighting period, whereby deterioration caused by both aging and temperature change is corrected.

In addition, with this structure, since a cumulative lighting period can be detected in each pixel, it is possible to cope with aging and temperature change of not only an entire pixel portion but also each pixel if data of the cumulative lighting period is used.

Note that data of voltage or data of current is supplied to each pixel constituting the pixel portion 23 according to a circuit structure of the pixel portion 23 or a structure of a drive circuit connected to it. In the case in which the data of voltage is supplied to each pixel, the correction unit IV corrects a signal voltage and supplies the corrected signal voltage to the pixel portion 23. Similarly, in the case in which the data of current is supplied to each pixel, the correction unit IV corrects a signal current and supplies the corrected signal current to the pixel portion 23. Note that both the constant voltage drive and the constant current drive can be applied to the display device having the above-mentioned structure.

Subsequently, in FIG. 2, the compensation function, which is a key of the present invention, consists of the temperature detection unit I, the storage unit II, the arithmetic operation unit III, the correction unit IV, and the count unit V. Since only a structure of the correction unit IV is different from FIG. 1, only the structure of the correction unit IV will be described here.

The correction data preparation circuit 16 prepares correction data using the data to be supplied from the counter 20 and the data of a relation between a time and a current-voltage characteristic corresponding to each temperature stored in the storage unit II. Subsequently, the D/A conversion circuit 24 converts the data to be supplied from the correction data preparation circuit 16 into an analog data, and calculates (adds) the analog data and a reference voltage 25, thereby correcting a potential of a power supply 26 to obtain a potential suitable for aging and temperature change.

Since a power supply line to be arranged in the pixel portion is generally connected with a power supply arranged outside, all potential of the power supply line is the same potential. Accordingly, in case of correcting a power supply potential, the power supply potential is corrected corresponding not to each pixel, but aging and temperature change. Therefore, a power supply 26 may be corrected with an average value calculated from data of each pixel which is supply from the counter 20

In addition, the correction circuit 17 crosses the correction data to be supplied from the correction data preparation circuit 16 and the video signal 21, and corrects the video signal 21 to a signal suitable for aging and temperature change. The video signal corrected in this way is supplied to the pixel portion 23.

In this way, the power supply 26 corrected to the potential suitable for aging and temperature change is used as a power supply in the pixel portion 23, a lighting period is further corrected according to an environmental temperature, and the signal is corrected using the corrected lighting period, whereby deterioration caused by both aging and temperature change is corrected. Note that only constant voltage drive can be applied to the display device having the above-mentioned structure.

As shown above, in case of correcting with a voltage correction unit, both a power supply potential and a video signal are corrected with a signal correction unit in addition to a voltage correction.

Note that, although not shown in figure, the pixel portion is set to be the constant current drive and is controlled by the above-mentioned method of a reference constant current, whereby it is possible to cause the display device to cope with not only the constant voltage drive but also the constant current drive.

In the structures shown in FIGS. 1 and 2, the circuits other than the pixel portion 23 may be formed integrally with the pixel portion 23 or may be connected to the pixel portion 23 using an FPC or the like as an external IC. In addition, circuits of publicly known structures can be used as the circuits such as the temperature detection element 11 and the amplifier 12. Moreover, a publicly known storage circuit only has to be used as the storage unit II. It is also possible to constitute the storage unit II using at least one of a volatile memory and a nonvolatile memory. Examples of the nonvolatile memory 19 include a ROM, an MROM, an FPROM, an EPROM, and an EEPROM. However, it may be necessary to add a periodical refresh function depending upon a memory to be used. In that case, it is desirable to incorporate a dedicated circuit in the memory.

In the present invention having the above-mentioned first and second structures, since a video signal to be supplied to a deteriorated pixel can be corrected, even if pixels forming a part of a pixel portion deteriorate, a high quality image can be provided without the occurrence of fluctuation in luminance. In addition, in the present invention having the above-mentioned second structure, since a desired current value can be supplied to a light-emitting element to obtain a desired luminance by correcting a video signal to be supplied to deteriorated pixel and correcting a power supply potential of a pixel even if the pixel is deteriorated, influence due to the deterioration can be suppressed. Moreover, in the present invention, since an operation by a user is not required basically, a long life of the display device as a product can be expected by continuing correction even after it is delivered to an end user.

### Embodiment 2

Temperature detection unit for detecting an environmental temperature is an essential element in the present invention. In this embodiment, an example of using a light-emitting element for monitor as the temperature detection element 11 will be described with reference to FIG. 4.

FIG. 4 shows only the temperature detection element 11, the amplifier 12, the A/D conversion circuit 13, and the pixel portion 23 in FIGS. 1 and 2. The temperature detection element 11 is equivalent to a light-emitting element 31 for monitor (hereinafter referred to as light-emitting element 31). One electrode 34 of the light-emitting element 31 is grounded and the other electrode 33 thereof is connected to a constant current source 32 and an FPC 27.

Here, a mechanism for the light-emitting element 31 to detect an environmental temperature will be described. Since the constant current source 32 is connected to the light-emitting element 31, a constant current is always flowing between both the electrodes. That is, a current value of the light-emitting element 31 is always constant. When an environmental temperature changes in this state, a resistance value of the light-emitting element 31 itself changes. At this point, since the current value of the light-emitting element 31 is always constant, a potential difference between both the electrodes of the light-emitting element 31 changes. A change in the environmental temperature is detected by detecting the change in the potential difference of the light-emitting element 31 due to this temperature change. More specifically, since a potential of the grounded electrode 34 does not change, a change in a potential of the electrode 33 connected to the constant current source 32 is detected. The change in the potential of the electrode 33 is supplied to the amplifier 12 via the FPC 27, and then, supplied to the acceleration data preparation circuit 14. Then, as described above, correction of a signal and correction of a power supply potential can be performed to compensate for aging and temperature change.

Note that the light-emitting element 31 may be used only as a light-emitting element for temperature monitor, but is not limited to this and may be used for display of an image. In addition, although the light-emitting element 31 is formed with the pixel portion 23 on an identical substrate, the present invention is not limited to this. The light-emitting element 31 may be externally attached as an IC rather than being integrally formed. However, in the case in which the light-emitting element 31 formed integrally with the pixel portion 23 is used as the temperature detection unit I, miniaturization of a casing can be realized compared with the case in which the external IC is used. In particular, since the display device of the present invention originally has characteristics of thin form and a light weight, it is effective to form the light-emitting element 31 integrally with the pixel portion 23 in order to make use of the characteristics.

This embodiment can be combined with Embodiment 1 arbitrarily.

### Embodiment 3

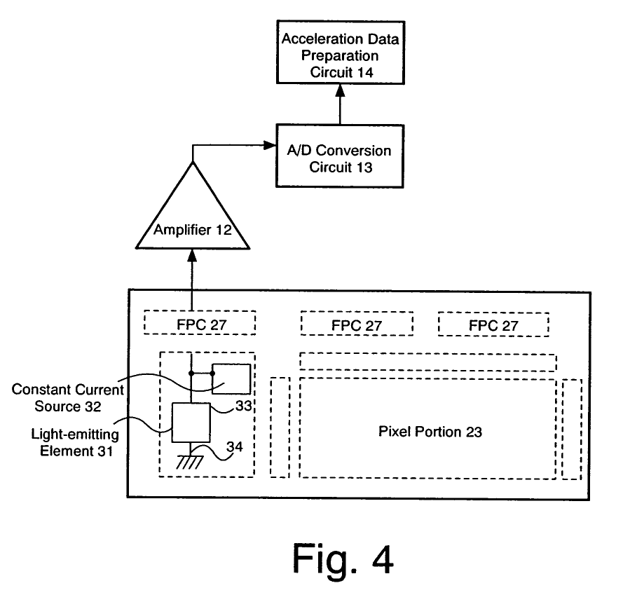

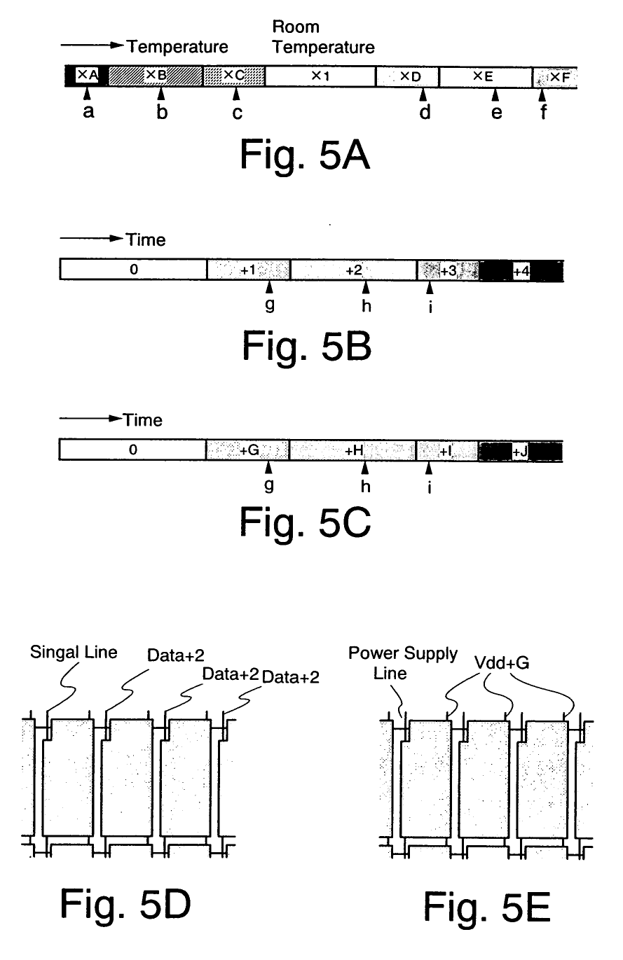

In this embodiment, an operation of the compensation function, which is a key of the present invention, will be described with reference to FIGS. 5A to 5E.

FIG. 5A shows a map in which correction amounts with respect to temperature change are set. Data of a temperature characteristic of a light-emitting element is measured in advance, and this map is prepared based upon a result of the measurement. Alphabets of A to F shown in FIG. 5A indicate correction amounts with respect to a video signal inputted to each pixel. Here, a room temperature is set to 1 with 25° C. as a reference. Then, it is desirable to set D to F, which are higher than the room temperature, to less than one, and set A to C, which are equal to or lower than the room temperature, to one or less. That is, since deterioration is facilitated in the case in which a temperature is higher than the room temperature, the number of gradations included in the video signal is increased by multiplying the number by D to F. In addition, in the case in which a temperature is equal to or lower than the room temperature, the number of gradations included in the video signal is maintained or decreased by multiplying the number by A to C. Note that, since a time-division drive is adopted here, increasing the number of gradations included in the video signal is equivalent to regarding a lighting period as a period longer than an actual lighting period. In addition, reducing the number of gradations included in the video signal is equivalent to regarding a lighting period as a period shorter than an actual lighting period.

Numerals 0 to +4 shown in FIG. 5B indicate correction amounts with respect to a video signal to be inputted to each pixel. That is, since a resistance value of a light-emitting element increases and a current value thereof decreases as time elapses, the number of gradations included in the video signal is increased by adding +1 to +4 to the number. In addition, alphabets of +G to +J shown in FIG. 5C indicate correction amounts with respect to a power supply potential. That is, since a resistance value of a light-emitting element increases and a current value thereof decreases as time elapses, the power supply potential is increased by adding +G to +J to the power supply potential.

Here, an operation at the time when the map of FIGS. 5A to 5C is used will be described. For example, if a temperature has reached a state of “d”, a multiplication of a video signal inputted to each pixel and D is found to increase the number of gradations of the signal. Then, if a cumulated lighting period, which is counted using a corrected signal, has reached a stage of “h”, +2 is always added to the video signal supplied to each pixel to correct the signal to a signal which is lightened by two gradations (FIG. 5D). Similarly, if the cumulated lighting time has reached a stage of “g”, +G is added to the power supply potential to correct the same (FIG. 5E).

Since the same power source line is generally connected with pixel portion, a power supply potential is corrected corresponding not to each pixel but to an aging and a temperature change of an entire pixel portion. Therefore, the correction power supply potential is based upon an average which is calculated from the data of cumulative lightning period of each pixel.

The present invention having the above-mentioned structure provides a display device which corrects deterioration due to both temperature change and aging and is capable of displaying a high quality image, and further has improved reliability. Moreover, in the present invention, since an operation by a user is not required basically, a long life of the display device as a product can be expected by continuing correction even after it is delivered to an end user.

This embodiment can be combined with Embodiments 1 and 2 freely.

### Embodiment 4

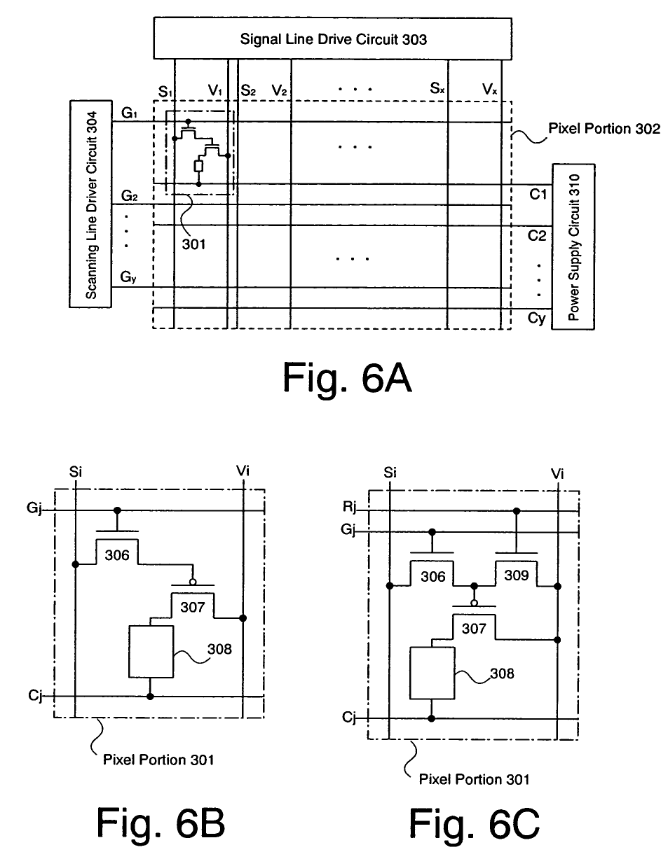

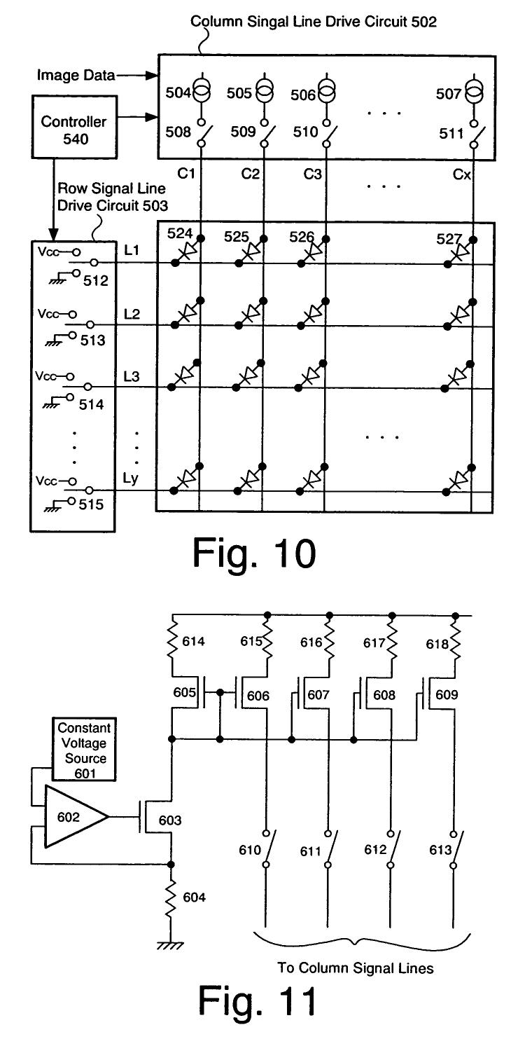

In this embodiment, the display device of the present invention will be schematically described with reference to FIGS. 6A to 6C. A display device is roughly classified into an active matrix type and a passive matrix type. Here, the active matrix type will be described with reference to FIGS. 6A to 6C, and the passive matrix type will be described with reference to FIGS. 10 and 11.

FIG. 6A schematically shows a display device of the active matrix type to which the present invention is applied. The display device has a pixel potion 302, a signal line drive circuit 303 arranged around the pixel portion 302, a scanning line drive circuit 304, and a power supply circuit 310. The pixel portion 302 has x signal lines S₁ to Sₓ and x power supply lines V₁ to Vₓ which are arranged in a column direction, and y scanning lines G₁ to G_{y} and y power supply lines C₁ to C_{y} which are arranged in a row direction (x and y are natural numbers). Then, an area surrounded by one of the signal lines S₁ to Sₓ, one of the power supply lines V₁ to Vₓ , one of the scanning lines G₁ to G_{y}, and one of the power supply lines C₁ to C_{y}, is equivalent to a pixel 301. Plural pixels 301 are arranged in a matrix shape in the pixel portion 302.

The signal line drive circuit 303, the scanning line drive circuit 304, and the like may be formed integrally with the pixel portion 302 on an identical substrate or may be arranged outside a substrate on which the pixel portion 302 is formed. Moreover, the signal line drive circuit 303 and the scanning line drive circuit 304 are not specifically limited in the number thereof. The signal line drive circuit 303 and the scanning line drive circuit 304 can be provided in any number according to a structure of the pixel 301. Note that a signal and power are supplied to the signal line drive circuit 303, the scanning line drive circuit 304, and the like from the outside via an FPC or the like (not shown). In addition, a power supply circuit is connected to the power supply lines C₁ to C_{y}. The power supply circuit may be formed integrally with the pixel portion 302 or may be arranged in the outside and connected to the pixel portion 302 by an FPC or the like. Then, in the present invention, potentials of a power supply circuit (not shown) connected to the power supply lines V₁ to Vₓ and the power supply circuit connected to the power supply lines C₁ to C_{y}, are corrected according to aging and an environmental temperature, whereby a display device is provided which corrects deterioration caused by both temperature change and aging and is capable of displaying a high quality image, and further has improved reliability

Note that a category of the display device includes a display panel in which a pixel portion having a light-emitting element and a drive circuit are enclosed between a substrate and a cover material, a module with an IC or the like implemented in the panel, a display, and the like. That is, the display device is equivalent to a general term of a panel, a module, a display, and the like. In addition, the light-emitting element has a structure including an anode and a cathode as well as a light-emitting layer sandwiched between the anode and the cathode. The light-emitting layer is constituted by a wide variety of materials such as organic materials and inorganic materials. Among them, examples of a representative light-emitting element include an organic light-emitting diode (OLED) which is constituted mainly by the organic materials.

Two representative examples of a structure of the pixel 301 arranged on the ith column and jth row of the pixel portion 302 will be illustrated, and the structures will be described with reference to FIGS. 6B and 6C. The pixel 301 shown in FIG. 6B has a switching transistor 306, a driving transistor 307, and a light-emitting element 308. The pixel 301 shown in FIG. 6C has a structure in which an erasing transistor 309 and a scanning line Rⱼ are added to the pixel 301 shown in FIG. 6B.

In FIGS. 6B and 6C, a gate electrode of the switching transistor 306 is connected to the scanning line Gⱼ, a first electrode thereof is connected to the signal line Sᵢ, and a second electrode thereof is connected to a gate electrode of the driving transistor 307. A first electrode of the driving transistor 307 is connected to the power supply line V₁ and a second electrode thereof is connected to one of electrodes of the light-emitting element 308. The other electrode of the light-emitting element 308 is connected to the power supply line Cⱼ.

In addition, in FIG. 6C, the switching transistor 306 and the erasing transistor 309 are connected in series and are arranged between the signal line Sᵢ and the power supply line Vᵢ. A gate electrode of the erasing transistor 309 is connected to the scanning line Rⱼ. Here, one of the electrodes of the light-emitting element 308 connected to the second electrode of the driving transistor 307 is called a pixel electrode, and the other electrode connected to the power supply line Cⱼ is called a counter electrode.

In FIGS. 6B and 6C, the switching transistor 306 has a function of controlling input of a signal to the pixel 301. Since the switching transistor 306 only has to have a function as a switch, a conduction type thereof is not specifically limited, and both an n-channel type and a p-channel type can be used.

In addition, in FIGS. 6B and 6C, the driving transistor 307 has a function of controlling light emission of the light-emitting element 308. Although a conduction type of the driving transistor 307 is not specifically limited, when the driving transistor 307 is the p-channel type, the pixel electrode becomes an anode and the counter electrode becomes a cathode. Further, when the driving transistor 307 is the n-channel type, the pixel electrode becomes a cathode and the counter electrode becomes an anode.

In FIG. 6C, the erasing transistor 309 has a function of stopping light emission of the light-emitting element 308. Since the erasing transistor 309 only has to have a function as a switch, a conduction type thereof is not specifically limited, and both the n-channel type and the p-channel type can be used.

A transistor to be arranged in the pixel 301 is not limited to a single gate structure with one gate electrode but may have a multi-gate structure such as a double gate structure with two gate electrodes or a triple gate structure with three gate electrodes. In addition, the transistor may have any of a top gate structure in which a gate electrode is arranged in an upper part of a semiconductor and a bottom gate structure in which a gate electrode is arranged in a lower part of a semiconductor. In addition, although a capacitive element is not provided in the pixel 301 shown in FIGS. 6B and 6C, the present invention is not limited to this and a capacitive element for holding a gate-source voltage of the transistor 307 may be arranged.

Next, FIG. 10 schematically shows a display device of the passive matrix type to which the present invention is applied. The display device has a pixel portion formed on a substrate, a column signal line drive circuit 502 arranged around the pixel portion, and a row signal line drive circuit 503. The pixel portion has x column signal lines C₁ to Cₓ arranged in a column direction, y row signal lines L₁ to L_{y} arranged in a row direction, and a plurality of light-emitting elements arranged in a matrix shape (x and y are natural numbers). The column signal line drive circuit 502, the row signal line drive circuit 503, and controller 540 which controls the column signal line driver circuit 502 and the row signal line driver circuit 503 are constituted by LSI chips and are connected to the pixel portion formed on the substrate by an FPC.

An operation of the display device of the passive matrix type will be hereinafter described briefly. First, it is assume that the row signal line L₁ on a first row is selected. Note that “selected” in this context is equivalent to “a switch 512 is connected to a GND.” Subsequently, when switches 508 to 511 of the column signal line drive circuit 502 are turned ON, currents supplied from constant current sources 504 to 507 are supplied to light-emitting elements 524 to 527 arranged on the first row, and the currents finally reach the GND connected to the row signal line L₁. At this point, a gradation indication is represented by an amount of currents to be supplied from the constant current sources 504 to 507 and a length of time in which currents are supplied to the light-emitting elements 524 to 527. Then, when the switches 508 to 511 are turned OFF, a switch 512 is connected to V_{CC}, and a reverse bias is applied to the light-emitting elements 524 to 527 on the first row. Such an operation described above is repeated from the first row to the last row.

FIG. 11 shows an example of a structure of the column signal line drive circuit 502. A constant voltage source 601 has a function of generating a constant voltage, and a constant voltage source with a small temperature coefficient such as a publicly known band gap regulator is used as the constant voltage source 601. The voltage generated from the constant voltage source 601 is converted into a constant current with a small temperature coefficient by an operational amplifier 602, a transistor 603, and a resistance 604. Then, the converted current is reversed in a current mirror circuit constituted by transistors 605 to 609 and resistances 614 to 618, and copied to be plural currents, and then, supplied to a column signal line via switches 610 to 613.

Then, in the present invention, image data to be inputted in the column signal line drive circuit 502 or a voltage to be generated from the constant voltage source 601 is corrected according to temperature change and aging, whereby a display device and a drive method therefor is provided, which corrects deterioration caused by both temperature change and aging and is capable of displaying a high quality image, and further has improved reliability.

This embodiment can be combined with Embodiments 1 to 3 freely.

### Embodiment 5

In this embodiment, a drive system to be applied to the present invention will be described briefly.

Drive systems at the time when a multi-gradation image is displayed using a display device are roughly classified into an analog drive and a digital drive. Both the drives are different in a method of controlling a light-emitting element in each state of light emission and non-light emission of the light-emitting element. The analog drive is a system for controlling an amount of current flowing to the light-emitting element to obtain a gradation. In addition, the digital drive is a system for driving the light-emitting element only in two states of ON (a state in which luminance is substantially 100%) and OFF (a state in which luminance is substantially 0%). Note that, in the digital drive, there have been proposed a system in which the digital drive and an area gradation drive are combined in order to represent a multi-gradation image, a system in which the digital drive and a time-division drive are combined (hereinafter generally referred to as time-division drive), and the like.

The time-division drive is a system for representing a gradation by controlling a period during which a light-emitting element emits light. More specifically, one frame period is divided into plural sub-frame periods having different lengths, and light emission or non-light emission of the light-emitting element in each period is selected, whereby gradation is represented by a difference of a length of a period during which the light-emitting element emits light in one frame period.

Note that, in a display device for performing multi-color display, plural sub-pixels corresponding to respective colors of RGB are provided in one pixel. Each sub-pixel may emit light of different luminance even if the same voltage is applied to it due to a difference of a current density of each material for RGB, a transmittance of a color filter, or the like. Thus, it is desirable to change a potential of a power supply line in each sub-pixel corresponding to each color or correct a signal to be inputted.

This embodiment can be combined with Embodiments 1 to 4 arbitrarily.

### Embodiment 6

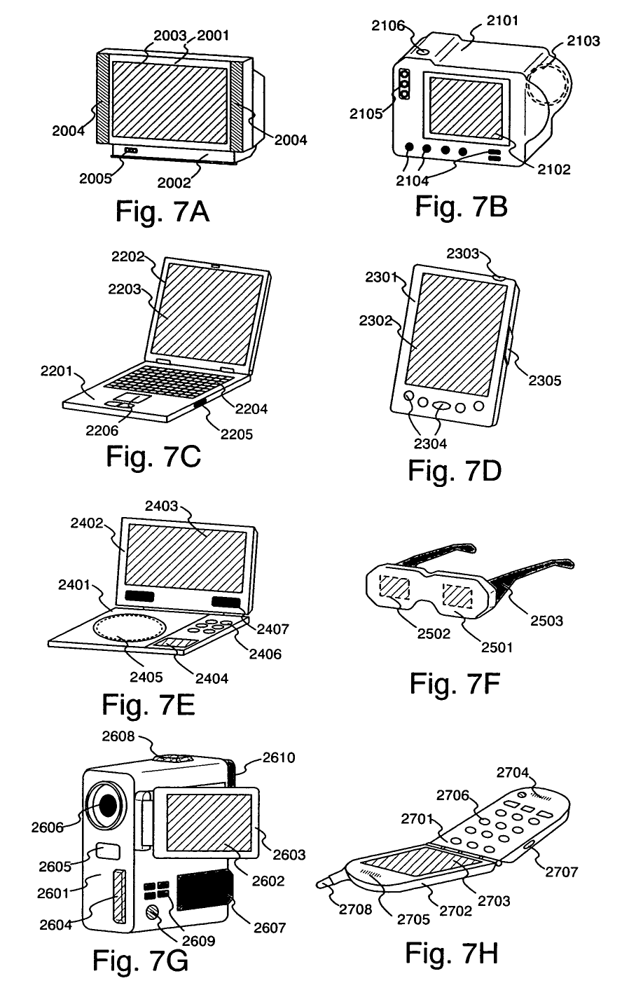

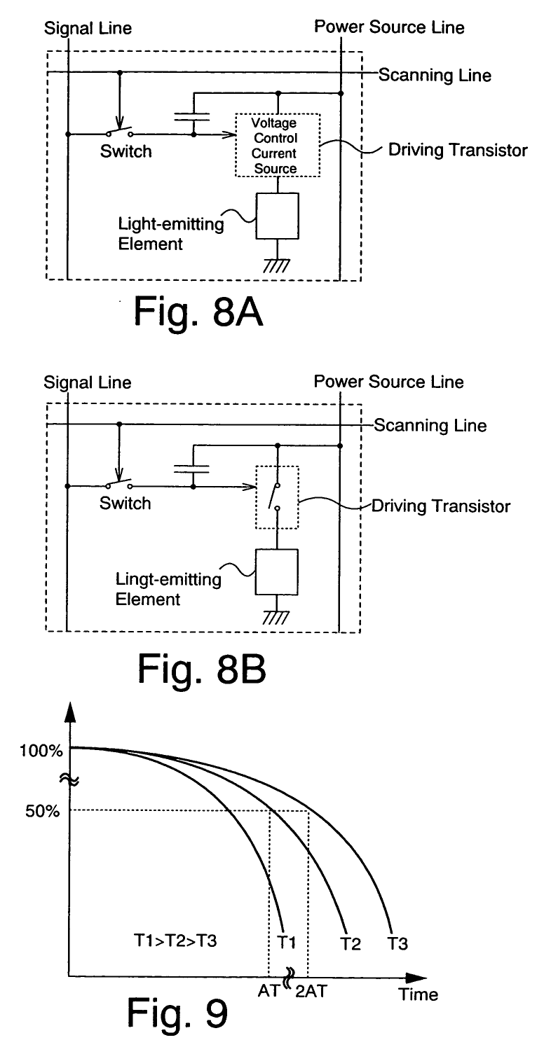

Electronic apparatuses applying the present invention include a video camera, a digital camera, a goggles-type display, a navigation system, a sound reproduction device (a car audio equipment etc.), a lap-top computer, a game machine, a portable information terminal (a mobile computer, a cellular phone etc.), an image reproduction device including a recording medium (more specifically, an device which can reproduce a recording medium such as a digital versatile disc (DVD) and so forth, and includes a display for displaying the reproduced image), or the like. FIGS. 7A to 7H respectively show various specific examples of such electronic apparatuses.

FIG. 7A illustrates a display device which includes a casing 2001, a support table 2002, a display portion 2003, a speaker portion 2004, a video input terminal 2005, or the like. The present invention is applicable to the display portion 2003. The display device is of the self-emission-type and therefore requires no backlight. Thus, the display portion thereof can have a thickness thinner than that of the liquid crystal display device. The display device is including the entire display device for displaying information, such as a personal computer, a receiver of TV broadcasting and an advertising display.

FIG. 7B illustrates a digital still camera which includes a main body 2101, a display portion 2102, an image receiving portion 2103, an operation key 2104, an external connection port 2105, a shutter 2106, or the like. The present invention is applicable to the display portion 2102.

FIG. 7C illustrates a lap-top computer which includes a main body 2201, a casing 2202, a display portion 2203, a keyboard 2204, an external connection port 2205, a pointing mouse 2206, or the like. The present invention is applicable to the display portion 2203.

FIG. 7D illustrated a mobile computer which includes a main body 2301, a display portion 2302, a switch 2303, an operation key 2304, an infrared port 2305, or the like. The present invention is applicable to the display portion 2302.

FIG. 7E illustrates a portable image reproducing device including a recording medium (more specifically, a DVD reproduction device), which includes a main body 2401, a casing 2402, a display portion A 2403, another display portion B 2404, a recording medium (DVD or the like) reading portion 2405, an operation key 2406, a speaker portion 2407, or the like. The display portion A 2403 is used mainly for displaying image information, while the display portion B 2404 is used mainly for displaying character information. The present invention is applicable to the display portion A 2403 and the display portion B 2404. In addition, the image reproduction device including a recording medium further includes a game machine or the like.

FIG. 7F illustrates a goggle type display (head mounted display) which includes a main body 2501, a display portion 2502, an arm portion 2503. The present invention is applicable to the display portion 2502.

FIG. 7G illustrates a video camera which includes a main body 2601, a display portion 2602, a casing 2603, an external connecting port 2604, a remote control receiving portion 2605, an image receiving portion 2606, a battery 2607, a sound input portion 2608, an operation key 2609, an eye piece portion 2610, or the like. The present invention is applicable to the display portion 2602.

FIG. 7H illustrates a cellular phone which includes a main body 2701, a casing 2702, a display portion 2703, a sound input portion 2704, a sound output portion 2705, an operation key 2706, an external connecting port 2707, an antenna 2708, or the like. The present invention is applicable to the display portion 2703. Note that the display portion 2703 can reduce power consumption of the cellular phone by displaying white-colored characters on a black-colored background.

When a brighter luminance of a light-emitting material becomes available in the future, the outputted light that contains image information can be used in front or rear projectors by enlarging through a lens or the like and projecting the light. The aforementioned electronic apparatuses are more likely to be used for display information distributed through a telecommunication path such as Internet, a CATV (cable television system), and in particular likely to display moving picture information. The display device is suitable for displaying moving pictures since the light-emitting material can exhibit high response speed. A portion of the display device that is emitting light consumes power, so it is desirable to display information in such a manner that the light-emitting portion therein becomes as small as possible. Accordingly, when the light-emitting device is applied to a display portion which mainly displays character information, e.g., a display portion of a portable information terminal, and more particular, a cellular phone or a sound reproduction device, it is desirable to drive the display device so that the character information is formed by a light-emitting portion while a non-emission portion corresponds to the background.

As set forth above, the present invention can be applied variously to a wide range of electronic apparatuses in all fields. The electronic apparatuses in this embodiment can be obtained by utilizing the constructions of a display device shown in Embodiments 1 to 5.

The present invention having the above-mentioned structure provides a display device which corrects deterioration caused by both temperature change and aging and is capable of displaying a high quality image, and further has improved reliability. More specifically, in the invention, since a video signal to be supplied to a deteriorated pixel can be corrected, even if pixels forming a part of a pixel portion deteriorate, a high quality image can be provided without the occurrence of fluctuation in luminance. In addition, since a desired current value can be supplied to a light-emitting element to obtain a desired luminance by correcting a power supply potential of a pixel even if the pixel is deteriorated, influence due to the deterioration can be suppressed. Moreover, in the present invention, an operation by a user is not required basically, a long life of the display device as a product can be expected by continuing correction even after it is delivered to an end user.

What is claimed is:

1. A display device comprising:
a display panel which is equipped with pixels including a light-emitting element;
a temperature detection unit which detects an ambient temperature;
a storage unit having stored therein a temperature characteristic and an aging characteristic of the light-emitting element;
an arithmetic operation unit which calculates a lighting period of each pixel using an output of the temperature detection unit, the temperature characteristic, and a video signal;
a count unit which counts a cumulated lighting period of each pixel using an output of the arithmetic operation unit; and
a correction unit which corrects a video signal to be inputted to each pixel using the aging characteristic and the cumulated lighting period and supplies the corrected video signal to the display panel.

2. A display device according to claim 1,
wherein the arithmetic operation unit calculates an acceleration factor from the output of the temperature detection unit and the temperature characteristic and also calculates a lighting period of each pixel from a multiplication of the video signal and the acceleration factor.

3. A display device according to claim 1,
wherein the temperature detection unit is a light-emitting element.

4. A display device comprising:
a display panel which is equipped with pixels including a light-emitting element;
a temperature detection unit which detects an ambient temperature;
a storage unit having stored therein a temperature characteristic and an aging characteristic of the light-emitting element;
an arithmetic operation unit which calculates a lighting period of each pixel using an output of the temperature detection unit, the temperature characteristic, and a video signal;
a count unit which counts a cumulated lighting period of each pixel using an output of the arithmetic operation unit; and
a correction unit which corrects a power supply potential using the aging characteristic and the cumulated lighting period and supplies the corrected power supply potential to the display panel.

5. A display device according to claim 4,
wherein the arithmetic operation unit calculates an acceleration factor from the output of the temperature detection unit and the temperature characteristic and also calculates a lighting period of each pixel from a multiplication of the video signal and the acceleration factor.

6. A display device according to claim 4,
wherein the temperature detection unit is a light-emitting element.

7. A drive method for a display device having a display panel equipped with pixels including a light-emitting element, temperature detection unit, storage unit having stored therein a temperature characteristic and an aging characteristic of the light-emitting element, arithmetic operation unit, count unit and correction unit, comprising the steps of:
a detecting ambient temperature by the temperature detection unit;
a calculating a lighting period of each pixel using an output of the temperature detection unit, the temperature characteristic, and a video signal by the arithmetic operation unit;
a counting a cumulated lighting period of each pixel using an output of the arithmetic operation unit by the count unit;
a correcting a video signal to be inputted to each pixel using the aging characteristic and the cumulated lighting period by the correction unit; and
a displaying an image using the corrected video signal by the display panel.

8. A drive method for a display device according to claim 7,
wherein the arithmetic operation unit calculates an acceleration factor from the output of the temperature detection unit and the temperature characteristic and also calculates a lighting period of each pixel from a multiplication of the video signal and the acceleration factor.

9. A drive method for a display device according to claim 7,
wherein the temperature detection unit is a light-emitting element.

10. A drive method for a display device having a display panel equipped with pixels including a light-emitting element, temperature detection unit, storage unit having stored therein a temperature characteristic and an aging characteristic of the light-emitting element, arithmetic operation unit, count unit, and correction unit, comprising the steps of:
detecting ambient temperature by the temperature detection unit;
calculating a lighting period of each pixel using an output of the temperature detection unit, the temperature characteristic, and a video signal by the arithmetic operation unit;
counting a cumulated lighting period of each pixel using an output of the arithmetic operation unit by the count unit;
correcting a power supply potential using the aging characteristic and the cumulated lighting period by the correction unit; and
displaying an image using the corrected power supply potential by the display panel.

11. A drive method for a display device according to claim 10,
wherein the arithmetic operation unit calculates an acceleration factor from the output of the temperature detection unit and the temperature characteristic and also calculates a lighting period of each pixel from a multiplication of the video signal and the acceleration factor.

12. A drive method for a display device according to claim 10,
wherein the temperature detection unit is a light-emitting element.

13. A display device comprising:
a display panel which is equipped with pixels including a light-emitting element;
a temperature detection unit which detects an ambient temperature;
a storage unit having stored therein a temperature characteristic and an aging characteristic of the light-emitting element;
a count unit which counts a cumulated lighting period of each pixel; and
a correction unit which corrects a video signal to be inputted to each pixel using the aging characteristic and the cumulated lighting period and supplies the corrected video signal to the display panel.

14. A display device according to claim 13,
wherein the temperature detection unit is a light-emitting element.

15. A display device comprising:
a display panel which is equipped with pixels including a light-emitting element;
a temperature detection unit which detects an ambient temperature;
a storage unit having stored therein a temperature characteristic and an aging characteristic of the light-emitting element;
a count unit which counts a cumulated lighting period of each pixel; and
a correction unit which corrects a power supply potential using the aging characteristic and the cumulated lighting period and supplies the corrected power supply potential to the display panel.

16. A display device according to claim 15, wherein the temperature detection unit is a light-emitting element.

17. A drive method for a display device having a display panel equipped with pixels including a light-emitting element, temperature detection unit, storage unit having stored therein a temperature characteristic and an aging characteristic of the light-emitting element, count unit and correction unit, comprising the steps of:
detecting ambient temperature by the temperature detection unit;
counting a cumulated lighting period of each pixel by the count unit;
correcting a video signal to be inputted to each pixel using the aging characteristic and the cumulated lighting period by the correction unit; and
displaying an image using the corrected video signal by the display panel.

18. A drive method for a display device according to claim 17,
wherein the temperature detection unit is a light-emitting element.

19. A drive method for a display device having a display panel equipped with pixels including a light-emitting element, temperature detection unit, storage unit having stored therein a temperature characteristic and an aging characteristic of the light-emitting element, arithmetic operation unit, count unit, and correction unit, comprising the steps of:
detecting ambient temperature by the temperature detection unit;
counting a cumulated lighting period of each pixel by the count unit;
correcting a power supply potential using the aging characteristic and the cumulated lighting period by the correction unit; and
displaying an image using the corrected power supply potential by the display panel.

20. A drive method for a display device according to claim 19,
wherein the temperature detection unit is a light-emitting element.
